(19) United States
(12) Patent Application Publication
(10) Pub. No.: US 2025/0122894 A1
(43) Pub. Date: Apr. 17, 2025

(54) ACTUATOR WITH INTEGRATED ACCUMULATOR

(71) Applicant: Ricky A. Weihl, Muskegon, MI (US)

(72) Inventor: Ricky A. Weihl, Muskegon, MI (US)

(21) Appl. No.: 18/378,870

(22) Filed: Oct. 11, 2023

(51) Int. Cl. F15B 15/14; F15B 1/04

(52) U.S. Cl. CPC F15B 15/1428; F15B 1/04

(57) ABSTRACT

A hydraulic actuator with an integrated accumulator for compressible gas is provided. The hydraulic actuator may include a gas side and a hydraulic side separated by a piston.

### TECHNICAL FIELD

The present application relates to a hydraulic actuator, and more particularly to a hydraulic actuator within an integrated accumulator.

### BACKGROUND

Hydraulic actuators are used in a variety of applications to move or control components of a system, including fields such as snow plows and commercial equipment. It is conventionally known that a hydraulic actuator may convert hydraulic energy (e.g., fluid pressure) into mechanical movement. Conventional hydraulic actuators include a cylinder in which a piston moves back and forth. The piston may be coupled to a rod at one side (e.g., a rod end) of the cylinder so that movement of the piston translates to movement of the rod relative to the other side (e.g., a cap end) of the cylinder. By controlling the supply of hydraulic fluid to either the rod side or the cap side of the cylinder, the piston can be moved within the cylinder. Such movement may translate to an overall lengthening or shortening of the cylinder and rod configuration.

Conventional hydraulic actuators, in some configurations, operate in conjunction with an external gas accumulator that is operable to buffer the flow of hydraulic fluid to and from the hydraulic actuator. In other conventional configurations, an external gas accumulator may supply gas directly to one side of the cylinder to affect operation of the piston. The external gas accumulator in these configurations often utilizes extra space and/or additional hose connections over conventional hydraulic actuator systems that operate without an external gas accumulator.

### SUMMARY OF THE DESCRIPTION

In general, one innovative aspect of the subject matter described herein can be embodied in a hydraulic actuator that includes a main cylinder including a rod side and a cap side and a longitudinal axis extending between the rod side and the cap side. The main cylinder may include inner and outer main surfaces axially aligned with the longitudinal axis. The hydraulic actuator may include a piston moveable within the main cylinder and separating the rod side and the cap side of the main cylinder. The piston may be coupled to a rod provided on the rod side of the main cylinder. The hydraulic actuator may include an accumulator cylinder including an inner and outer accumulator surfaces, where the inner accumulator surface is spaced by a distance from the outer main surface to define an accumulation space between the outer main surface and the inner accumulator surface. The accumulation space may be fluidly coupled with one of the rod side or cap side of the main cylinder, and where gas provided in the accumulation space is compressible and operable to bias the piston toward the other of the rod side or cap side of the main cylinder.

The foregoing and other embodiments can each optionally include one or more of the following features, alone or in combination. In particular, one embodiment includes all the following features in combination.

In some embodiments, one of the rod side or the cap side of the main cylinder is defined as a gas side, and the other of the rod side or the cap side of the main cylinder is defined as a hydraulic side.

In some embodiments, the hydraulic actuator may include an opening provided in the main cylinder to provide fluid communication between the gas side and the accumulation space.

In some embodiments, the hydraulic actuator may include a spacer disposed between the outer main surface of the main cylinder and the inner accumulator cylinder. The spacer may include a plurality of gas passages that provide fluid coupling between the accumulation space and the gas side of the main cylinder.

In some embodiments, the hydraulic actuator may include a cap side accumulation space defined between 1) at least one of the spacer and cap side end of the main cylinder and 2) an end cap of the hydraulic actuator that is coupled to a cap side end of the accumulator cylinder, and where a cap side end of the main cylinder is spaced away from the end cap of the hydraulic actuator.

In some embodiments, the accumulation space may be fluidly coupled with the gas side of the main cylinder.

In some embodiments, the hydraulic actuator may include a hydraulic port fluidly coupled to the hydraulic side of the main cylinder, and a gas port fluidly coupled to the gas side of the main cylinder and the accumulation space.

In some embodiments, the hydraulic actuator may include a gland nut coupled to a rod side end of the main cylinder. The gland nut may include an opening through which the rod is capable of moving, and where the gland nut is operable to seal the rod side of the main cylinder.

In some embodiments, the hydraulic actuator may include a cap side coupler and a rod side coupler.

In some embodiments, the hydraulic actuator may include an end cap disposed on a cap side end of the main cylinder, and where the cap side coupler is connected to the end cap.

In some embodiments, the hydraulic actuator may include a rod side ring coupled to both the outer main surface of the main cylinder and a rod side end of the accumulator cylinder.

In some embodiments, the hydraulic actuator may include a flange surrounding the outer main surface proximal to a rod side end of the main cylinder.

In some embodiments, the hydraulic actuator may include a cap side ring coupled to both the outer main surface of the main cylinder and a cap side end of the accumulator cylinder.

In general, one innovative aspect of the subject matter described herein can be embodied in a hydraulic actuator including a main cylinder with a rod side and a cap side and a longitudinal axis extending between the rod side and the cap side. The main cylinder may include inner and outer main surfaces axially aligned with the longitudinal axis. One of the rod side or the cap side of the main cylinder may be defined as a gas side, and the other of the rod side or the cap side of the main cylinder is defined as a hydraulic side. The hydraulic actuator may include a piston moveable within the main cylinder and constructed to separate the rod side and the cap side of the main cylinder. The piston may be coupled to a rod provided on the rod side of the main cylinder. The hydraulic actuator may include an accumulation space fluidly coupled to the main cylinder. The accumulation space may be defined at least in part by the outer main surface of the main cylinder, wherein gas provided in the accumulation space is compressible and operable to bias the piston toward the other of the rod side or cap side of the main cylinder.

The foregoing and other embodiments can each optionally include one or more of the following features, alone or in combination, In particular, one embodiment includes all the following features in combination.

In some embodiments, the hydraulic actuator may include an accumulator cylinder with inner and outer accumulator surfaces. The inner accumulator surface may be spaced by a distance from the outer main surface to define an accumulation space between the outer main surface and the inner accumulator surface.

In some embodiments, the hydraulic actuator may include a spacer disposed between the outer main surface of the main cylinder and the inner accumulator cylinder. The spacer may include a plurality of gas passages that provide fluid coupling between the accumulation space and the gas side of the main cylinder.

In some embodiments, the hydraulic actuator may include a cap side accumulation space defined between the spacer and an end cap of the hydraulic actuator that is coupled to a cap side end of the accumulator cylinder. A cap side end of the main cylinder may be spaced away from the end cap of the hydraulic actuator.

In some embodiments, the hydraulic actuator may include an opening provided in the main cylinder to provide fluid communication between the gas side and the accumulation space.

In some embodiments, the hydraulic actuator may include a hydraulic port fluidly coupled to the hydraulic side of the main cylinder, and a gas port fluidly coupled to the gas side of the main cylinder and the accumulation space.

In some embodiments, the hydraulic actuator may include a gland nut coupled to a rod side end of the main cylinder and including an opening through which the rod is capable of moving. The gland nut may be operable to seal the rod side of the main cylinder.

These and other advantages and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 depicts a sectional view of the hydraulic actuator in FIG. 2.

FIG. 2 shows a side view of a hydraulic actuator in accordance with one embodiment.

FIG. 3 depicts a spacer ring in accordance with one embodiment.

FIG. 4 shows a sectional view of the hydraulic actuator in FIG. 5.

FIG. 5 shows a side view of a hydraulic actuator in accordance with one embodiment.

FIG. 6 shows a sectional view of the hydraulic actuator in FIG. 7.

FIG. 7 shows a side view of a hydraulic actuator in accordance with one embodiment.

### DESCRIPTION

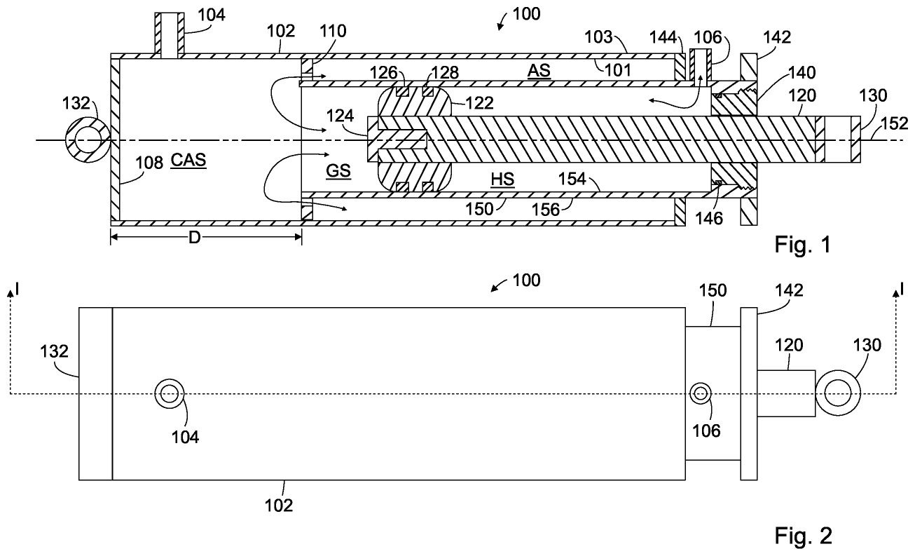

A hydraulic actuator according to one embodiment of the present disclosure is shown in FIGS. 1-2 and generally designated 100. The hydraulic actuator 100 may be utilized in connection with a variety of applications, including but not limited to snow plow applications. The hydraulic actuator 100 is described in conjunction with a hydraulic port 106 operable to receive and discharge hydraulic fluid from the hydraulic actuator 100 under the control of a hydraulic control system (not shown). The hydraulic control system may direct fluid to and from the hydraulic actuator 100 in order to move a piston of the hydraulic actuator 100, as described herein. The hydraulic control system, which is separate from the hydraulic actuator 100, is considered conventional and therefore, for purposes of disclosure, little effort is provided in describing aspects of the hydraulic control system other than receipt and discharge of hydraulic fluid to control movement of the piston 122.

The hydraulic actuator 100 in accordance with one embodiment may include an integrated accumulator for compressible gas. The hydraulic actuator 100 may include a gas side GS and a hydraulic side HS separated by a piston 122. Compressible gas on the gas side GS may operate to bias the piston 122, and to move the piston 122 based on the hydraulic fluid on the hydraulic side HS being discharged by the hydraulic control system (e.g., with the hydraulic control system provided in a float mode that enables hydraulic fluid to discharge from the hydraulic side HS of the hydraulic actuator 100). The volume of gas to bias the piston 122 in some circumstances needs to be larger than the volume available in a hydraulic actuator with a conventional external, separate accumulator. The integrated accumulator according to one embodiment of the present disclosure may provide such additional volume in a space efficient manner over hydraulic actuators that utilize external, separate accumulators.

The hydraulic actuator 100 in the illustrated embodiment includes a main cylinder 150 that includes a rod side and a cap side and a longitudinal axis 152 extending between the rod side and the cap side. The main cylinder 150 may include an inner main surface 154 and an outer surface 156 axially aligned with the longitudinal axis 152. The inner main surface 154 may be honed so that the surface finish is sufficiently fine to facilitate hydraulic operation of the hydraulic actuator 100, enabling the piston 122 to establish a seal and separate the rod side and the cap side of the main cylinder 150. The piston 122 may include first and second seals 126, 128 operable to establish a seal (e.g., a wiping seal) between the rod side and the cap side of the main cylinder 150. In operation, as described herein, one of the rod side or the cap side of the main cylinder 150 may correspond to a gas side GS, and the other of the rod side or the cap side may correspond to a hydraulic side HS. In the illustrated embodiment, the hydraulic side HS corresponds to the rod side and the gas side GS corresponds to the cap side of the main cylinder 150—however, alternatively, the hydraulic side HS and the gas side GS may be swapped so that the gas side GS corresponds to the rod side of the main cylinder 150 and the hydraulic side HS corresponds to the cap side of the main cylinder 150. The hydraulic side HS may be fluidly coupled to the hydraulic port 106, and the gas side GS may be fluidly coupled to the gas port 104. In practice, the gas port 104 may be a valve operable to enable supplying gas to the gas side GS prior to operation and to remain closed during operation. The hydraulic port 106, on the other hand, may be configured to supply and discharge hydraulic fluid from the hydraulic side HS with respect to the hydraulic control system.

The first and second seals 126, 128 that establish the seal of the piston 122 may separate the gas side GS from the hydraulic side HS during operation. The piston 122 may be aluminum, machined from billet or cast and then machined. The piston 122 is not limited to any particular type of material and may be formed from any one or more materials, including aluminum and steel.

The piston 122 may be coupled to a rod 120, as described herein, and the side of the piston 122 on which the rod is coupled to corresponds to the rod side of the main cylinder 150. The rod 120 may be connected to the piston 122 by a rod bolt 124. The rod 120 may include a rod side coupler 130 disposed on an end opposite the piston 122 and configured to connect via a pin or other type of connection to an implement depending on the application.

The main cylinder 150 may be threaded proximal to a rod side end of the main cylinder 150 and configured to engage a gland nut 140 that seals the rod side opening of the main cylinder 150. The gland nut 140 includes an opening through which the rod 120 is operable to slide in and out of the main cylinder 150. The opening of the gland nut 140 may form a hydraulic seal with the rod to maintain pressure within the main cylinder 150 and prevent leakage of hydraulic fluid as the rod moves within the gland nut 140. The gland nut 140 may include a seal 146 operable to engage the inner main surface 154 of the main cylinder 150, thereby preventing leakage of hydraulic fluid. Alternatively, as described herein, the rod side of the main cylinder 150 may be filled with gas instead of hydraulic fluid. The gland nut 140 in this configuration may prevent leakage of gas in a manner similar to the case for hydraulic fluid provided in the rod side as described previously.

The hydraulic cylinder 100 in the illustrated embodiment includes an accumulator cylinder 102 with an inner surface 101 and an outer surface 103. The inner surface 101 may be spaced by a distance from the outer surface 156 of the main cylinder 150. This spacing between the inner surface 101 of the accumulator cylinder 102 and the outer surface 156 of the main cylinder 150 may define an accumulation space AS between the two surfaces. The volume of the accumulation space AS may be a function of the distance between the inner surface 101 of the accumulator cylinder 102 and the outer surface 156 of the main cylinder 150, the cross-sectional shapes of the accumulator cylinder 102 and the main cylinder 150, respectively, and the length of the accumulator cylinder 102 and the main cylinder 150. The accumulator cylinder 102 in the illustrated embodiment includes a circular cross-sectional shape. However, the present disclosure is not so limited—the cross-sectional shape of the accumulator cylinder 102, as well as the main cylinder 150, may be any type of shape suitable for the target application. The accumulation space AS may be defined at least in part by the outer surface 156 of the main cylinder 150. This configuration may conserve space over conventional external accumulator configurations.

In operation, the accumulation space AS may be fluidly coupled to the gas side GS of the main cylinder 150. This way, gas may flow between the accumulation space AS and the gas side GS of the main cylinder 150. As the piston 122 moves to compress gas within the gas side GS of the main cylinder 150, gas may flow into and compress with respect to the accumulation space AS. Conversely, as the piston 122 moves to allow expansion of gas within the gas side GS of the main cylinder 150, gas may flow from and expand with respect to the accumulation space AS. The gas within the gas side GS of the main cylinder 150 and the accumulation space AS may operate under compression to bias the piston 122 toward the hydraulic side HS of the main cylinder 150. In the illustrated embodiments, the gas may bias the piston 122 such that the hydraulic actuator 100 is biased to an extended state, if the hydraulic control system allows discharge of hydraulic fluid from the hydraulic side HS (e.g., a float mode for hydraulic fluid). Alternatively, with the gas side corresponding to the rod side of the main cylinder 150, the gas may bias the piston 122 such that the hydraulic cylinder 100 is biased to a contracted state, if the hydraulic control system allows discharge of hydraulic fluid from the hydraulic side HS.

The hydraulic actuator 100 may include a rod side ring 144 coupled to both the outer surface 156 of the main cylinder 150 and a rod side end of the accumulator cylinder 102. The rod side ring 144 may define a wall of the accumulation space AS between the inner surface 101 of the accumulator cylinder 102 and the outer surface 156 of the main cylinder 150. The rod side ring 144 may be welded to the main cylinder 150 and the accumulator cylinder 102 in order to form an air tight seal therebetween. In some configurations, the heat generated during welding of the rod side ring 144 to the main cylinder 150 may cause portions of the rod end, such as the threads, to be within a heat affected zone. A flange 142 may be welded (e.g., via spaced welds about the periphery of the main cylinder 150) to support the main cylinder 150 and maintain the circular integrity of the main cylinder 150 during welding of the rod side ring 144 to the main cylinder 150, particularly with respect to maintaining integrity (e.g., to avoid distortion) of the threads of the main cylinder 150 that engage the gland nut 140.

The hydraulic actuator 100 in the illustrated embodiment may include an accumulator cylinder 102 that extends beyond a cap side end of the main cylinder 150 by a distance D. This extension of the accumulator cylinder 102 may provide a cap side accumulation space CAS in addition to the accumulation space AS and a volume of the gas side GS of the main cylinder 150, further increasing the overall volume for gas to move, compress, and expand within the hydraulic actuator 100. In this configuration, an end cap 108 may be joined with a cap side of the accumulator cylinder 102 to seal the cap side accumulation space CAS of the hydraulic actuator 100. Increasing the volume of the cap side accumulation space CAS (or any other accumulation space) may provide slower ramp up for pressure in the system, effectively allowing less force to compress the gas in the hydraulic actuator 100. Changing the volume of the accumulator space AS and/or the cap side accumulation space CAS can enable tuning of the hydraulic actuator 100 for different applications—e.g., greater volume provides a more cushioned response to movement of hydraulic actuator 100 to compress the gas whereas less volume provides a quick and firm response to movement that compresses the gas.

A cap side coupler 132 may be connected to the end cap 108 of the hydraulic actuator 100. Similar to the rod side coupler 130, the cap side coupler 132 may be connected to an implement or another component depending on the application for the hydraulic actuator 100.

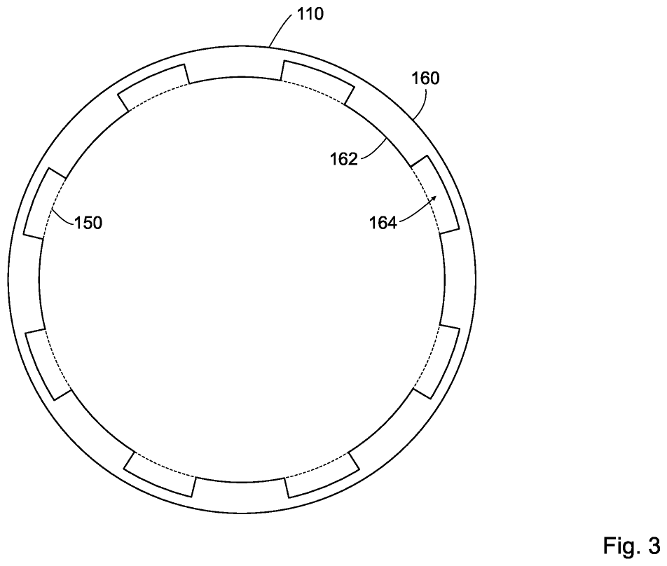

A spacer 110 may be provided between the cap side end of the main cylinder 150 and the accumulator cylinder 102 in order to support the main cylinder 150 in the axial alignment with the longitudinal axis 152. The spacer 110 is shown in further detail in FIG. 3 and may include an outer surface 160 that is operable to engage the inner surface 101 of the accumulator cylinder 102. An inner segmented surface 162 of the spacer 110 may be separated by a plurality of gas passages 164 that provide fluid coupling between the accumulation space AS and the gas side GS of the main cylinder 150. The inner segmented surface 162 of the spacer 110 may engage the outer surface 156 of the main cylinder 150, thereby supporting the main cylinder 150 in the axial alignment with the accumulator cylinder 102. Although the gas passages 164 are shown provided between the main cylinder 150 and the body of the spacer 110, the gas passages 164 may be configured differently. For example, the gas passages 164 may be provided via holes in the spacer 110 or between the accumulator cylinder 102 and the body of the spacer 110 (e.g., segmenting the outer surface 160 of the spacer 110).

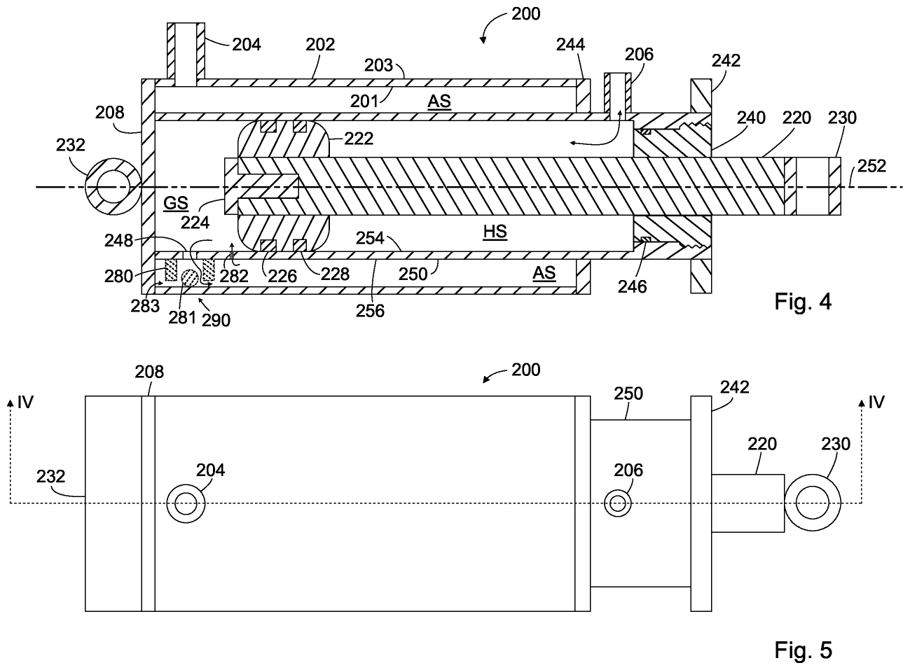

A hydraulic actuator in accordance with one or more embodiments is shown in FIGS. 4 and 5 and generally designated 200. The hydraulic actuator 200 maybe similar to the hydraulic actuator 100 but with several exceptions. In the illustrated embodiment, the hydraulic actuator 200 includes a main cylinder 250, a piston 222, a rod 220, a rod bolt 224, a first seal 226, a second seal 228, a gland nut 240, a seal 246, a rod side coupler 230, a flange 242, a rod side ring 244, a cap side coupler 232, a hydraulic port 206, and a gas port 204, similar respectively to corresponding components of the hydraulic cylinder 100. For instance, the main cylinder 250 may include an inner surface 254 and an outer surface 256, and the piston 222 may separate a gas side GS from a hydraulic side HS of the main cylinder 150. As another example, the gland nut 240 may seal an open end on the rod side of the main cylinder 150.

The hydraulic actuator 200 differs from the hydraulic actuator 100 primarily with respect to absence of a cap side accumulation space CAS, with the end cap 208 coupled to both respective cap side ends of an accumulator cylinder 202 and the main cylinder 250. The main cylinder 250 in this configuration may include an opening 248 (e.g., a port) that enables flow of gas between the accumulation space AS and the gas side GS of the main cylinder 150. The end cap 208 may support the main cylinder 250 in axial position with respect to the longitudinal axis 252 of the hydraulic actuator 200 and the accumulator cylinder 202.

Optionally, the hydraulic actuator 200 may include a retainer 280 and a float 281 (e.g., a metal ball) that floats within an annular space defined by the retainer 280. The retainer 280 may surround the opening 248 to allow the float 281 to move relative to the opening 248. The height of the retainer 280 may provide a gap 283 between the retainer 280 and the interior surface 201 of the accumulator cylinder 202. The float 281 may be sufficiently small to allow significant air flow through the gap 283 between the retainer 280 and the interior surface 201 as the air flows from the gas side GS of the hydraulic actuator 200 to the accumulation space AS. On the other hand, the float 281 may be sufficiently sized to engage the opening 248 and prevent air flow through the opening 248 in a reverse direction with air flowing from the accumulation space AS to the gas side GS of the hydraulic actuator 200. The float 281 and the retainer 280 may operate in conjunction with the opening 248 to provide a type of one-way valve 290 for air flow from the gas side GS of the hydraulic actuator 200 to the accumulation space AS. It is noted that alternative one way valve configurations may optionally be provided and the present disclosure is not limited to a specific configuration. The optional one way valve 290 may operate in conjunction with a secondary flow path 282 that enables air flow from the accumulation space AS to the gas side GS of the hydraulic actuator 200, where the air flow rate through the secondary flow path 282 is limited relative the air flow rate through the one way valve 290. The difference in air flow rate capabilities of the one way valve 290 and the secondary flow path 282 may enable the hydraulic actuator 200 in the illustrated embodiment to retract at a rate that is significantly faster than its ability to extend in response to air flow from the accumulation space AS back into the gas side GS of the hydraulic actuator 200. In other words, retraction may result pressure on the piston 122 causing fluid flow from the gas side GS of the hydraulic actuator 200 through the one way valve configuration into the accumulation space AS, whereas extension due to expansion of the fluid in the accumulation space back into the gas side GS may be slowed due to the restrictive flow rate of the secondary flow path 282.

Although the one-way valve 290 and the secondary flow path 282 are described in conjunction with the hydraulic actuator 200—it is to be understood that the one way valve 90 and the secondary flow path 282 may be provided with any of the other hydraulic actuator embodiments described herein. It is also to be understood that, although the secondary flow path 282 is described separate from the one way valve 290, in alternative configurations the secondary flow path 282 may be integral to the one way valve 290.

Similar to accumulator cylinder 102 of the hydraulic actuator 100, the accumulator cylinder 202 may include an inner surface 201 and an outer surface 203. The inner surface 201 may be spaced apart from the outer surface 256 of the main cylinder 250 to define at least a portion of the accumulation space AS. In other words, the accumulation space AS of the hydraulic actuator 200, like the hydraulic actuator 100, may be defined at least in part by the outer surface 256 of the main cylinder 250. The volume of the accumulation space AS may be defined in a manner similar to the accumulation space AS described in conjunction with the hydraulic actuator 100. For instance, the distance between the outer surface 256 of the main cylinder 250 and the inner surface 201 of the accumulator cylinder 202, the respective cross-sectional shapes of the main cylinder 250 and the accumulator cylinder 202, and the length of the accumulator cylinder 202 may define the volume of the accumulation space AS of the hydraulic actuator 200.

The hydraulic actuator 200, like the hydraulic actuator 100, may utilize gas within the gas side GS of the main cylinder 250 and the accumulation space AS to bias the piston 222 toward the rod side of the hydraulic actuator 200 with the hydraulic fluid in the hydraulic side HS allowed to discharge from the hydraulic side HS. In other words, the gas utilized within the hydraulic actuator 200 may bias the hydraulic actuator toward an extended state. Supply of hydraulic fluid to the hydraulic port 206 and the hydraulic side HS of the main cylinder 250 may compress the gas provided within the gas side GS and the accumulation space as of the hydraulic actuator 200. The amount of gas (e.g., pressure) within the hydraulic actuator 200 may be controlled by supply of gas under pressure to the gas port 204 so that an initial gas pressure can be provided thereto.

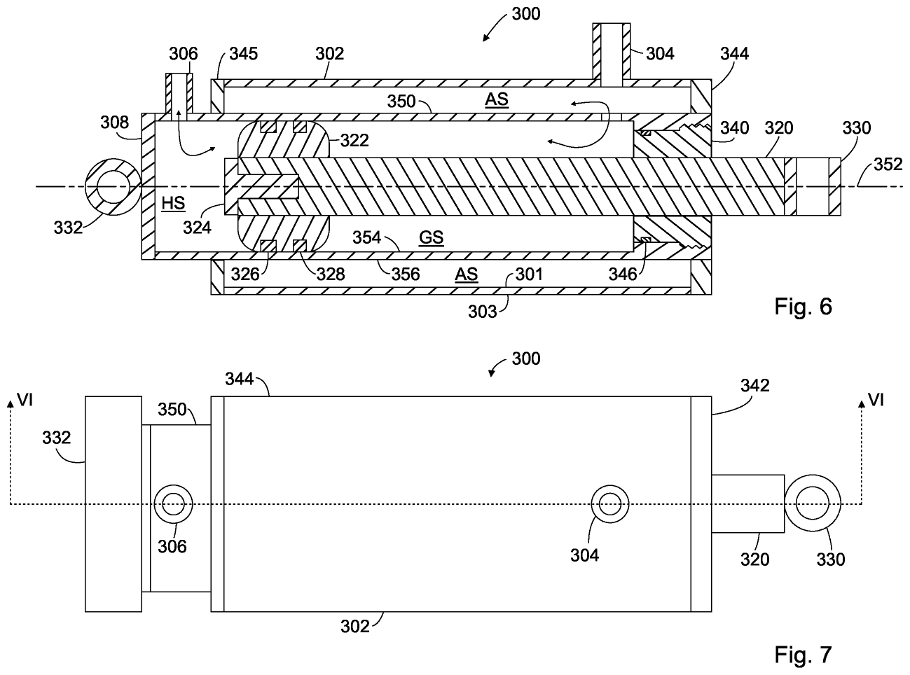

A hydraulic actuator in accordance with one or more embodiments is shown in FIGS. 6 and 7 and generally designated 300. The hydraulic actuator 300 maybe similar to the hydraulic actuator 200 but with several exceptions. In the illustrated embodiment, the hydraulic actuator 300 includes a main cylinder 350, a piston 322, a rod 320, a rod bolt 324, a first seal 326, a second seal 328, a gland nut 340, a seal 346, a rod side coupler 330, a rod side ring 344, a cap side coupler 332, a hydraulic port 306, and a gas port 304, similar respectively to corresponding components of the hydraulic cylinder 100. For instance, the main cylinder 350 may include an inner surface 354 and an outer surface 356, and the piston 322 may separate a gas side GS from a hydraulic side HS of the main cylinder 350. As another example, the gland nut 340 may seal an open end on the rod side of the main cylinder 350.

The hydraulic actuator 300 differs from the hydraulic actuator 100 in that the hydraulic actuator 300 is configured with the hydraulic side Hs and the gas side GS being reversed, so that the hydraulic side HS is on the cap side of the main cylinder 350 and the gas side GS is on the rod side of the main cylinder 350. The accumulator cylinder 302 of the hydraulic actuator 300 is reconfigured relative to the accumulator cylinder 202 of the hydraulic actuator 200, with the accumulator cylinder 302 located on the rod side of the hydraulic actuator 300. The rod side ring 344, like the rod side ring 244, is coupled to both the main cylinder 350 and the accumulator cylinder 302 in order to form a seal and define at least a portion of the accumulation space AS. The gland nut 140 may also provide a seal with the rod 320 that prevents leakage of gas from the gas side GS and the accumulation space AS. Similar to the hydraulic actuator 200, the accumulation space AS of the hydraulic actuator 300 is defined at least in part by the outer surface 356 of the main cylinder 350.

The main cylinder 350 may be provided with an opening 348, similar to the opening 248 of the main cylinder 250, with the exception of the opening 348 being disposed in proximity to the rod side end of the hydraulic cylinder 300 instead of the cap side end. The opening 348 may provide fluid communication between the gas side of the hydraulic actuator 300 and the accumulation space AS.

The accumulator cylinder 302 in the illustrated embodiment may be coupled to the main cylinder 350 at the cap side end of the accumulator cylinder 302 via a cap side ring 345, similar to the rod side ring 344 except located on the other end of the accumulator cylinder 302. The cap side ring 345 may be welded to both the accumulator cylinder 302 and the main cylinder 350, similar to the connection between the rod side ring 344, the accumulator cylinder 302, and the main cylinder 350.

The hydraulic port 306 of the hydraulic actuator 300 is disposed on the cap side end of the hydraulic actuator 300 opposite the configuration depicted in conjunction with the hydraulic actuator 200. The hydraulic port 306 may be in fluid communication with the hydraulic side HS of the main cylinder 350 on the cap side of the piston 322. The hydraulic port 306 may be positioned differently depending on the configuration.

The hydraulic actuator 300 may include an end cap 308 configured to seal a cap side of the main cylinder 350.

The hydraulic actuator 300, with the gas side GS and the hydraulic side HS swapped, may be configured to bias the piston 322 toward the cap side of the hydraulic actuator 300. In this way, the hydraulic actuator 300 may be configured to bias toward a contracted state if the hydraulic fluid in the hydraulic side HS is allowed to discharge. Conversely, hydraulic fluid provided to the HS under pressure may compress the gas in the gas side GS and extend the hydraulic actuator 300 by moving the rod 320 toward the rod end of the main cylinder 350.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

1. A hydraulic actuator comprising:
a main cylinder including a rod side and a cap side and a longitudinal axis extending between the rod side and the cap side, the main cylinder including inner and outer main surfaces axially aligned with the longitudinal axis;
a piston moveable within the main cylinder and separating the rod side and the cap side of the main cylinder, the piston coupled to a rod provided on the rod side of the main cylinder;
an accumulator cylinder including an inner and outer accumulator surfaces, the inner accumulator surface being spaced by a distance from the outer main surface to define an accumulation space between the outer main surface and the inner accumulator surface; and
wherein the accumulation space is fluidly coupled with the rod side of the main cylinder, wherein the piston is operable to separate gas on the rod side of the main cylinder from hydraulic fluid on the cap side of the main cylinder, and wherein gas provided in the accumulation space is compressible and operable to bias the piston toward the cap side of the main cylinder.

2. The hydraulic actuator of claim 1 wherein the rod side of the main cylinder is defined as a gas side, wherein the cap side of the main cylinder is defined as a hydraulic side.

3. The hydraulic actuator of claim 2 comprising an opening provided in the main cylinder to provide fluid communication between the gas side and the accumulation space.

4. The hydraulic actuator of claim 2 comprising a spacer disposed between the outer main surface of the main cylinder and the inner accumulator surface, the spacer including a plurality of gas passages that provide fluid coupling between the accumulation space and the gas side of the main cylinder.

5. (canceled)

6. The hydraulic actuator of claim 2 wherein the accumulation space is fluidly coupled with the gas side of the main cylinder.

7. The hydraulic actuator of claim 2 comprising:
a hydraulic port fluidly coupled to the hydraulic side of the main cylinder; and
a gas port fluidly coupled to the gas side of the main cylinder and the accumulation space.

8. The hydraulic actuator of claim 1 comprising a gland nut coupled to a rod side end of the main cylinder and including an opening through which the rod is capable of moving, wherein the gland nut is operable to seal the rod side of the main cylinder.

9. The hydraulic actuator of claim 1 comprising a cap side coupler and a rod side coupler.

10. The hydraulic actuator of claim 9 comprising an end cap disposed on a cap side end of the main cylinder, and wherein the cap side coupler is connected to the end cap.

11. The hydraulic actuator of claim 1 comprising a rod side ring coupled to both the outer main surface of the main cylinder and a rod side end of the accumulator cylinder.

12. The hydraulic actuator of claim 11 comprising a flange surrounding the outer main surface proximal to a rod side end of the main cylinder.

13. The hydraulic actuator of claim 11 comprising a cap side ring coupled to both the outer main surface of the main cylinder and a cap side end of the accumulator cylinder.

14. A hydraulic actuator comprising:
a main cylinder including a rod side and a cap side and a longitudinal axis extending between the rod side and the cap side, the main cylinder including inner and outer main surfaces axially aligned with the longitudinal axis, the rod side of the main cylinder is defined as a gas side, the cap side of the main cylinder is defined as a hydraulic side;
a piston moveable within the main cylinder and separating the rod side and the cap side of the main cylinder, the piston coupled to a rod provided on the rod side of the main cylinder; and
an accumulation space fluidly coupled to the main cylinder, the accumulation space defined at least in part by the outer main surface of the main cylinder, wherein gas provided in the accumulation space is compressible and operable to bias the piston toward the cap side of the main cylinder.

15. The hydraulic actuator of claim 14 comprising an accumulator cylinder including inner and outer accumulator surfaces, the inner accumulator surface being spaced by a distance from the outer main surface to define an accumulation space between the outer main surface and the inner accumulator surface.

16. The hydraulic actuator of claim 15 comprising a spacer disposed between the outer main surface of the main cylinder and the inner accumulator cylinder, the spacer including a plurality of gas passages that provide fluid coupling between the accumulation space and the gas side of the main cylinder.

17. The hydraulic actuator of claim 16 comprising a cap side accumulation space defined between the spacer and an end cap of the hydraulic actuator that is coupled to a cap side end of the accumulator cylinder, wherein a cap side end of the main cylinder is spaced away from the end cap of the hydraulic actuator.

18. The hydraulic actuator of claim 14 comprising an opening provided in the main cylinder to provide fluid communication between the gas side and the accumulation space.

19. The hydraulic actuator of claim 14 comprising:
a hydraulic port fluidly coupled to the hydraulic side of the main cylinder; and
a gas port fluidly coupled to the gas side of the main cylinder and the accumulation space.

20. The hydraulic actuator of claim 14 comprising a gland nut coupled to a rod side end of the main cylinder and including an opening through which the rod is capable of moving, wherein the gland nut is operable to seal the rod side of the main cylinder.
